(19) United States
(12) Patent Application Publication
(10) Pub. No.: US 2009/0020672 A1
(43) Pub. Date: Jan. 22, 2009

(54) SUPPORTING APPARATUS

(75) Inventors: Jo Fei Lai, Taipei (TW); Hsin An Hsu, Taipei (TW)

Correspondence Address: APEX JURIS, PLLC, 12360 LAKE CITY WAY NORTHEAST, SUITE 410, SEATTLE, WA, 98125, US

(73) Assignee: FIRST INTERNATIONAL COMPUTER, INC., Taipei (TW)

(21) Appl. No.: 12/102,353

(22) Filed: Apr. 14, 2008

(30) Foreign Application Priority Data
Jul. 20, 2007 (TW) 096126705

(51) Int. Cl. F16M 11/00

(52) U.S. Cl. 248/274.1

(57) ABSTRACT

A supporting apparatus comprises a cover, a rotation seat, a supporting frame and a knob component. The rotation seat is configured in a inlaid part of the cover and disposed with a limit element capable of being let in a limit slot of the cover; the supporting frame is disposed with a positioning part capable of being let in an accepting part of the rotation seat to allow the supporting frame to be positioned on the rotation seat; the knob component is installed on the positioning part of the supporting frame, and rotated between a buckling position and a release position relatively to the supporting frame; the supporting frame is coupled to the rotation seat to support the cover when the knob component is rotated to the buckling position and an angle of the supporting frame at which the cover is supported can be adjusted by changing a position of the limit element in the limit slot.

### CROSS-REFERENCES TO RELATED APPLICATIONS

This non-provisional application claims priority under 35 U.S.C. §119(a) on Patent Application No(s). 096126705 filed in Taiwan, R.O.C. on Jul. 20, 2007, the entire contents of which are hereby incorporated by reference.

### FIELD OF INVENTION

The present invention relates to a supporting apparatus, and more particularly to an angle adjustable supporting apparatus.

### BACKGROUND

The current common electronic devices such as liquid crystal display, digital frame are mostly disposed with a supporting frame on a back cover so as to support the electronic device to allow it to be placed on a table face for use's viewing convenience. However, when a user wants to change the placement way of an electronic device owing decoration effect or space limitation, for example, change an accumbent placement of the electronic device to erective placement thereof, a supporting frame configured originally in the electronic device must be detached, another proper supporting frame is replaced, and the placement way of the electronic device can then be changed.

As a locking structure of screw and screw hole is mostly used for assembling a supporting frame of the current electronic device, tools must be used for detaching the supporting frame; this is very inconvenient. Besides, detached components such as screws are not easy to be kept and stored; it always causes a future assembly not to be done because the components are scattered everywhere. Furthermore, the current supporting frame structures are all used for supporting electronic devices and unable to allow the user to adjust a displacement angle to comply with a placement position to cause the placement way of the electronic device to be too monotonous.

Therefore, for improving a supporting frame, allowing a user to mount and detach the supporting frame on and from an electronic device easily and further allowing the user to adjust a placement angle of the electronic device depending on vision effect or space limitation as well as increasing the decoration effect of the electronic device, the present invention is proposed.

### SUMMARY

A supporting apparatus disclosed by the present invention comprises a cover, a rotation seat, a supporting frame and a knob component, in which the cover comprises an inlaid part and at least a limit slot, and the slot is positioned on a bottom of the inlaid part; a rotation seat is installed in the inlaid part and comprises a limit element, accepting part, at least one breach and at least one fastening part, in which the limit element is used for letting in the limit slot and movable in the limit slot and the fastening part is positioned at a periphery of the breach; the knob component comprises a propping part; the supporting frame comprises a positioning part and at least one breach, in which the positioning part allows the propping part to be placed in and used for letting in the accepting part to cause the supporting frame to be positioned in the rotation seat. The breaches are positioned on a periphery of the positioning part, and the knob component is rotated between a buckling position and a release position relatively to the supporting frame. When the knob component is rotated to the buckling position, the propping part is passed through the openings and breaches to uphold the fastening part to cause the supporting frame to be coupled to the rotation seat to support the cover.

There is no tool is needed according to the present invention, and no coupling components such as screws and screw hole are needed, and a supporting frame can then be detached from or mounted on the cover to enable the assembly operation to be easier and more convenient. Besides, when the supporting frame is installed on the cover, a user can rotate the supporting frame to drive rotation seat to rotate to change the position of a limit element in a limit slot thereby adjusting an angle of the supporting frame at which the cover is supported.

### BRIEF DESCRIPTION OF THE DRAWINGS

The present invention can be more fully understood by reference to the following description and accompanying drawings, in which:

FIG. 1 is an exploded view of a supporting frame of a first preferred embodiment according to the present invention;;

FIG. 2A is a schematic view of the supporting frame while being assembled of the first embodiment according to the present invention;

FIG. 2B is a schematic view of the supporting frame while being assembled of the first embodiment according to the present invention;

FIG. 3A is a schematic view of the supporting frame while being assembled of the first embodiment according to the present invention;;

FIG. 3B is a schematic view of the supporting frame while being assembled of the first embodiment according to the present invention;

FIG. 4 is a schematic view of a knob component of the first embodiment according to the present invention;

FIG. 5A is a schematic view of a supporting frame in an accumbence state of the first embodiment according to the present invention;

FIG. 5B is a schematic view of a supporting frame in an erection state of the first embodiment according to the present invention; and

FIG. 6 is a schematic view of a supporting frame of a second preferred embodiment.

### DETAILED DESCRIPTION

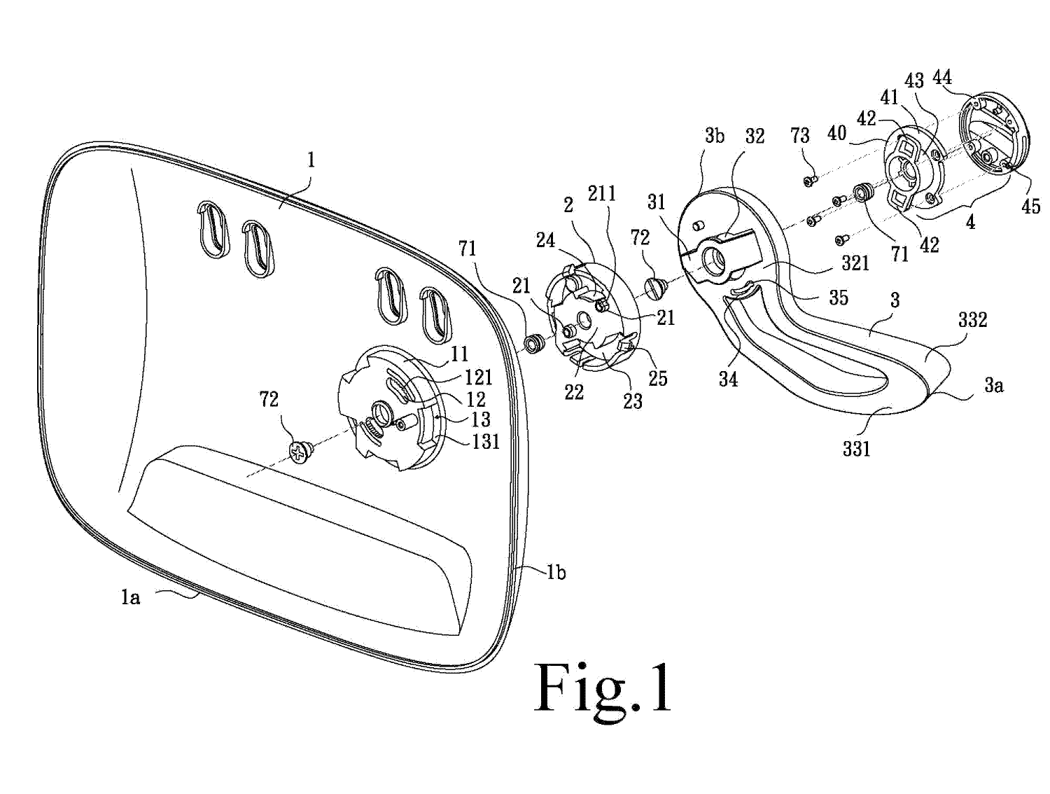

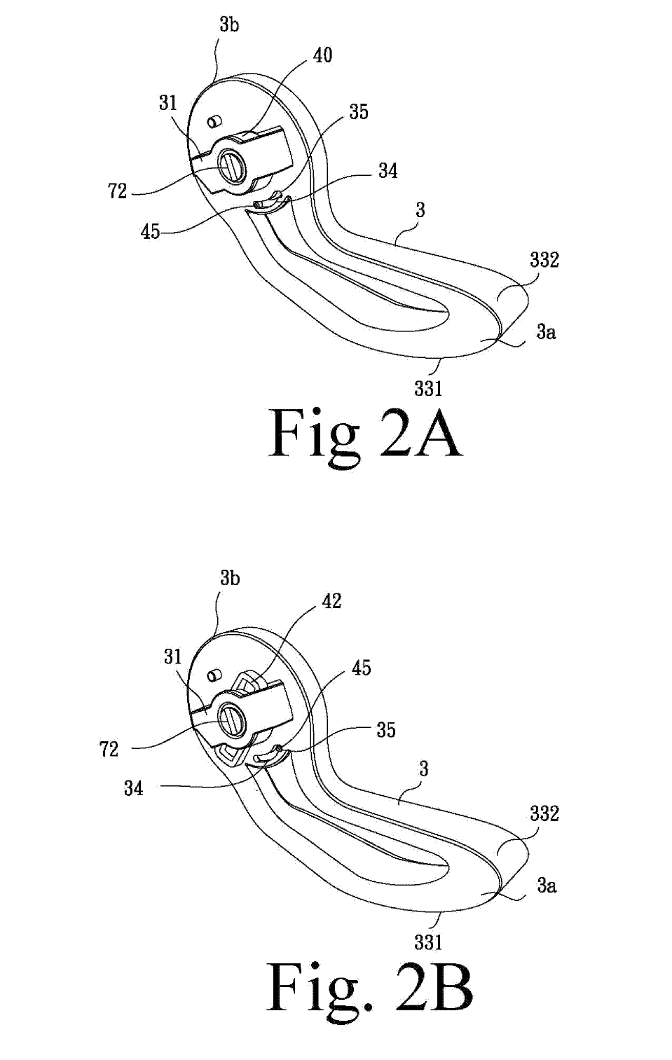

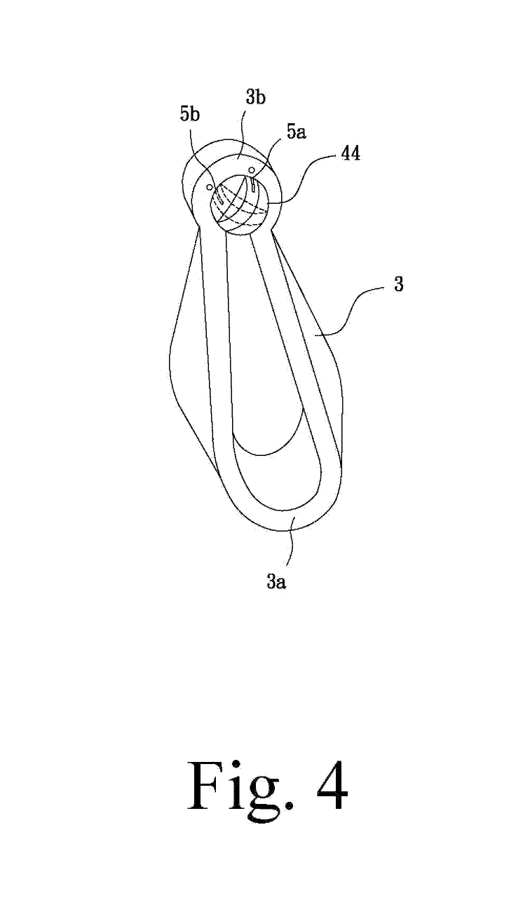

Please refer to FIGS. 1, 2A, 2B, 3A, 3B and 4. FIGS. 1, 2A, 2B, 3A, 3B and 4 show a supporting frame of a first preferred embodiment according to the present invention.

A supporting apparatus comprises a cover 1, rotation seat 2, a supporting frame 3 and a knob component 4.

The cover 1 is a rectangular parallelepiped with a first side 1a and a second side 1b adjacent to each other and disposed with an inlaid part 11 and limit slots 12, in which the inlaid part 11 is a projecting body in the direction coming out of the drawing of FIG. 1 and an indented groove in the opposite direction. The limit slots 12 are positioned on a bottom of the inlaid part 11, and each limit slot 12 approximately is a curved slot. Furthermore, the cover 1 is a rear cover or side cover of an electronic device such as digital frame, liquid crystal display or the cover 1 is allowed to mount an electronic device directly.

The rotation seat 2 is configured in the inlaid part 11 and disposed with limit elements 21, an accepting part 22 and a fastening part 23, in which the limit element 21 is used for letting in the limit slot 12 and can be moved along the inside of the limit slot 12, the accepting part 22 is a projecting body in the direction coming out of the drawing of FIG. 1 and an indented groove in the opposite direction, and a side thereof is disposed with a breach 24 as well as the fastening part 23 is position at a periphery of the breach 24.

A buckling hole 13 with a flange 131 may be disposed on a bottom of the inlaid part 11 of the cover 1 mentioned above, and a corresponding hook 25 is disposed on the rotation seat 2. The rotation seat 2 can be positioned in the inlaid part 11when the hook 25 is hooked on the flange 131 of the buckling hole 13 and in the meantime, the limit element 21 is limited to move in the limit slot 12 so as to limit a rotational angle of the rotation seat 2 in the inlaid part 11 and drive the hook 25 to move in the buckling hole 13 simultaneously. Besides, a locking nut 71 may be installed in a central hole of the rotation seat 2 to allow the rotation seat to be locked in the inlaid part 11 through a screwing element 72.

The knob component 4 comprises a matching element 40 and a knob element 44, in which the matching element 40 is provided with a main body 41, a propping part 42 is extendedly disposed on the main body 41 and a groove 43 is formed between the main body 41 and the propping part 42. Furthermore, the knob element 44 is fixed on the matching element 40, in which the knob element 44 may be locked on the matching element 40 through the screwing element 73 or the matching element 40 and the knob element 44 may be formed integrally.

The supporting frame 3 is provided with a first side 3a and a second side 3b, in which the first side 3a is used for propping against a plane 8, the second side 3b is disposed with a positioning part 31. The positioning part 31 is a projecting body in the direction coming out of the drawing of FIG. 1 and an indented groove in the opposite direction and an indented groove portion of the positioning part 31 allows the propping part 42 to be placed in. Furthermore, the matching element 40 mentioned above may be pre-installed with the locking nut 71 to lock the supporting frame 3, the matching element 40 and the knob element 44 all together through the screwing element 72. A projection portion of the positioning 31 may be let in the accepting part 22 so as to allow the supporting frame 3 to be positioned on the rotation seat 2. Besides, an opening 32 is disposed at two sides of a rim of the positioning part 31 and a fastening sheet 321 is disposed at a rim of the opening 32. A first curve part 331 and a second curve part 332 may be disposed on the first side 3a of the supporting frame 3 and used for propping against the plane 8.

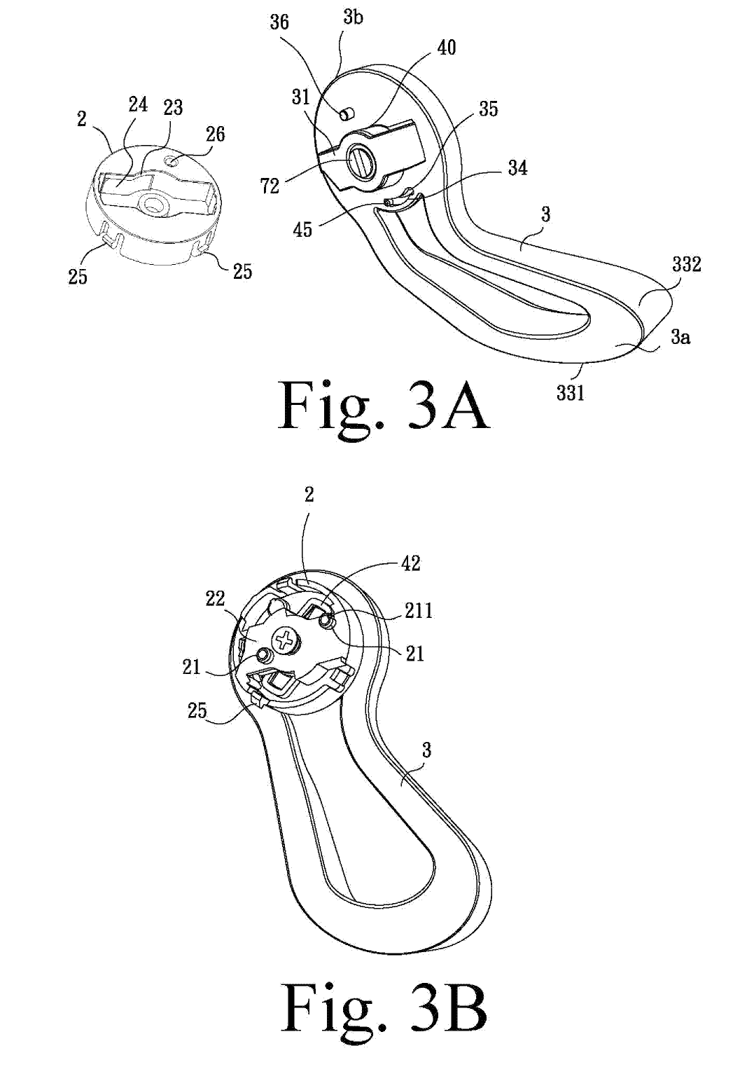

According to the supporting apparatus disclosed by the present invention, the rotation seat 2 may be disposed with a through hole 26, and the supporting frame 3 is then disposed with a corresponding pin 36 (as FIG. 3A shows). When a user assembles the supporting frame 3 on the rotation seat 2 (as FIG. 3B shows), he must insert the pin 36 into the through hole 26 to allow the supporting frame 3 to take the positioning part 31 as an axis to rotate and in the meantime, the rotation seat 2 is driven to rotate thereby adjusting the angle of the supporting frame 3.

Furthermore, the knob component 4 may be rotated between a buckling position 5a and a release position 5b relatively to the supporting frame 3. When the knob component 4 is rotated to the buckling position 5a, the matching element 40 is driven to rotate to cause the propping part 42 to pass through the opening 32 and the breach 24 in sequence to prop against the fastening part 23 to allow the supporting frame 3 to be coupled to the rotation seat 2 to support the cover 1; when the knob component 4 is rotated to the release position 5b, the propping part 42 will not prop against the fastening part 23 and is completely positioned in the positioning part 31 to cause the knob component 4 to be released from the positioning part 31, and the supporting frame 3 can be separated from the rotation seat 2.

The supporting apparatus disclosed by the present invention further comprises a positioning pin 45 positioned on the matching element 40 or the knob element 44. A slide groove 34 and a positioning hole 35 are disposed on the supporting frame 3, in which the positioning hole 35 is positioned at one end of the slide groove 34 and communicated with the slide groove 34. When a user rotates the knob component 4, the positioning pin 45 will be driven to move in the slide groove 34 at the same time, and when the knob component 4 is rotated to the buckling position 5a, the positioning pin 45 will be moved into the positioning hole 35.

When the supporting apparatus of the present invention is assembled, the rotation seat 2 is first configured into the inlaid part 11 of the cover 1, the hook 25 is buckled in the buckling hole 13 to enable the rotation seat 2 to be positioned in the inlaid part 11, and the knob component 4 is then configured in the positioning part 31 and coupled to the supporting frame 3 by engaging the screwing element 72 with the locking nut 71 as FIG. 3A shows. Thereafter, the positioning part 31 of the supporting frame 3 is let in the accepting part 22 of the rotation seat 2 as showing in FIG. 3B, the knob component 4 is then rotated to the buckling position 5a at this time, i.e. the propping part 42 is caused to pass through the opening 32 and the breach 24 in sequence by rotating the matching element 40 and the fastening part 23 of the rotation seat 2 and the fastening sheet 321 of the supporting frame 3 are caused to position in the groove 43. In the meantime, the propping part 42 is propped against the fastening part 23 and the main body 41 is propped against the fastening sheet 321 thereby being able to couple the supporting frame 3 to the rotation seat 2 to support the cover 1.

If a user wants to detach the supporting frame 3 from the rotation seat 2, he only needs to rotate the knob component 4 to the release position 5b; the propping part 42 is not pressed against the fastening part 23 and positioned completely in the positioning part 31, and he can then separate the knob component 4 from the positioning part 31 and take the supporting frame 3 out of the rotation seat 2. When the user wants to do the storage, he may install the knob component 4 on the supporting frame 3 under the condition that the knob component 4 is separated from the rotation seat 2. Thereby, not only the storage is convenient, but also losing any component to cause an assembly in the future not to be unable to be carried out can be avoided. The present invention allows a user to be unnecessary to use other tools or a coupling component such as screws plus screw holes he can then detach or install the supporting frame 3 to allow the assembly to be easier and more convenient.

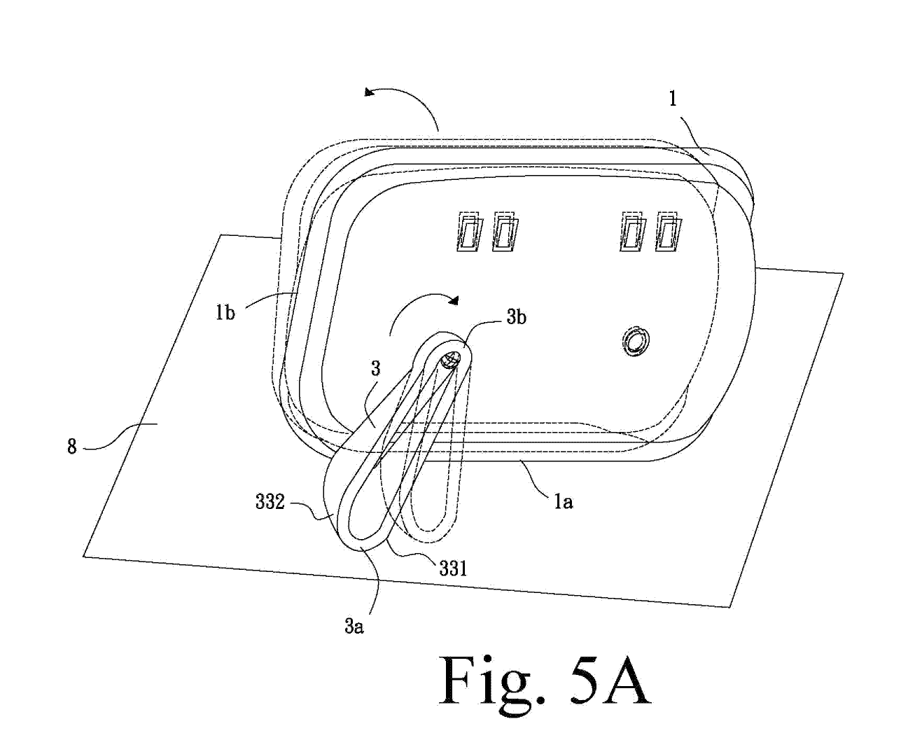

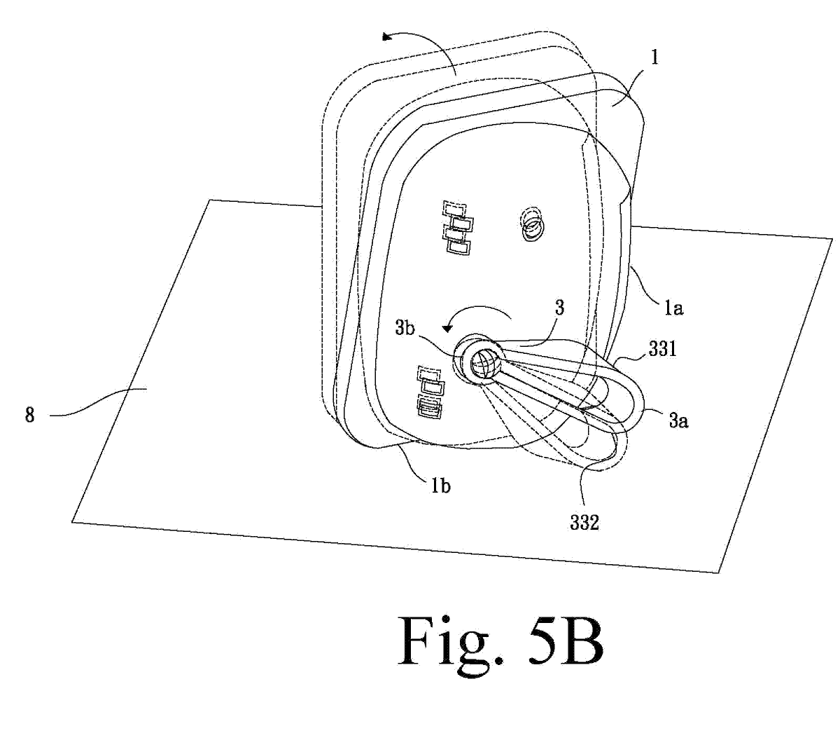

Please refer to FIGS. 5A and 5B. If the first side 1 a of the cover 1 is taken as a bottom side to place on the plane 8, the supporting frame 3 can then propped against the plane 8 through the first curve part 331; if the second side 1b of the cover 1 is taken as a bottom side to place on the plane 8, the supporting frame 3 can then propped against the plane 8 through the second curve part 332 thereby allowing a user to adjust the placing way of the cover 1 freely. Besides, when the knob component 4 is positioned at the buckling position 5a, the user may rotate the supporting frame 3 to drive the rotation seat 2 to rotate through the positioning part 31 to change the position of the limit element 21 in the limit slot 12 and in the meantime, the limit element 21 of the rotation seat 2 is moved between two ends of the limit slot 12 to cause the supporting frame 3 to be moved between a solid line position and a dotted line position shown in FIGS. 5A and 5B to form different angles thereby being capable of adjusting the angle of the supporting frame 3 for supporting the cover 1 and further allowing the cover 1 to have different placing angle; this not only allows the placement to be easier but also elevates the decoration effect.

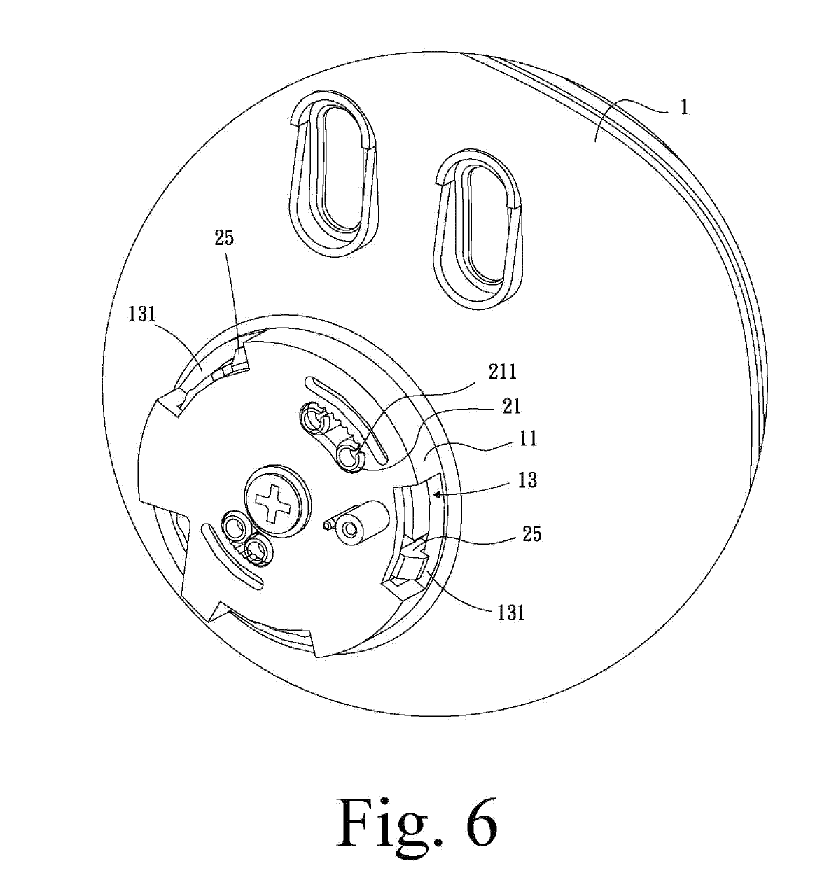

Please refer to FIG. 6. FIG. 6 is a perspective view showing a supporting apparatus of a second preferred embodiment according to the present invention.

A plurality of tooth parts 121 may be disposed on the limit slot 12 of the cover 1 and a gap 211 is then disposed on each limit element 21 of the rotation seat 2. When a user rotate the supporting frame 3, the gap 211 of the limit element 21 is engaged with the different tooth part 121 to adjust a position of the limit element 21 in the limit slot, and each tooth part 121 can provide a supporting angle thereby allowing the user to adjust the angle of the supporting frame 3 at which the cover 1 is supported.

The supporting apparatus disclosed by the present invention allows a user to detach or assemble the supporting frame 3 bare-handedly to enable the assembly operation to be easier and more convenient. Furthermore, the knob component 4 may be installed on the supporting frame 3 under a condition of being separated from the rotation seat 2; this not only is convenient on the storage but also can prevent any component from being lost to cause a future assembly to be impossible. Besides, the user may place the cover 1 freely depending on requirement and space placing condition to enable the placing way of the cover 1 to be more diversified, and the placing of the cover 1 can be freely adjusted depending on vision appeal to elevate the decoration effect.

Additional advantages and modifications will readily occur to those skilled in the art. Therefore, the invention in its broaden aspects is not limited to the specific details and representative embodiments shown and described herein. Accordingly, various modifications may be made without departing from the spirit or scope of the general inventive concept as defined by the appended claims and their equivalents.

What is claimed is:

1. A supporting apparatus, comprising:
a cover, comprising a inlaid part and at least one limit slot, the limit slot being positioned on a bottom of the inlaid part;
a rotation seat, configured in the inlaid part and comprising a limit element, an accepting part, at least one breach and at least one fastening part, the limit element used for letting in the limit slot and moving in the limit slot, the fastening part being position at a rim of the breach;
a knob component, comprising at least one propping part and a groove; and
a supporting frame, comprising a positioning part and at least one opening, the positioning part allowing the propping part of the knob component to be placed therein and used for letting in the accepting part to cause the supporting frame to be positioned on the rotation seat, the opening being positioned at a rim of the positioning part, and the knob component being rotated between a coupling position and a release position relatively to the supporting frame, when the knob component is rotated to the coupling position, the propping part being passed through the opening and breach to prop against the fastening part to enable the supporting frame to be coupled to the rotation seat to support the cover;
whereby, an angle of the supporting part at which the supporting frame is supported is adjusted by changing a position of the limit element in the limit slot.

2. The supporting apparatus according to claim 1, wherein the cover further comprises a first side and a second side adjacent to each other, the supporting frame further comprises a first curve part and a second curve part, when the cover takes the first side as a bottom side to be placed on a plane, the supporting frame is propped against the plane through the first curve part, and when the cover takes the second side as a bottom side to be placed on the plane, the supporting frame is propped against the plane through the second curve part.

3. The supporting apparatus according to claim 1, wherein the limit slot comprises a plurality of tooth parts, the limit element comprises a gap, a position of the limit element in the limit slot is adjusted by engaging the gap with the different tooth part.

4. The supporting apparatus according to claim 1, wherein the inlaid part comprises at least one buckling hole and at least one flange, the flange is positioned on one side of the buckling hole, and the rotation seat further comprises at least one hook buckled on the flange.

5. The supporting apparatus according to claim 1, wherein the rotation seat is locked to the inlaid part through a screwing element.

6. The supporting apparatus according to claim 1, wherein the rotation seat further comprises a through hole, the supporting frame further comprises a pin used for inserting in the through hole.

7. The supporting apparatus according to claim 1, wherein the supporting frame further comprises a slide groove and a positioning hole, the positioning hole is positioned at one end of the slide groove.

8. The supporting apparatus according to claim 7, wherein the knob component further comprises a matching element and a knob element, the knob element is fixed on the matching element.

9. The supporting apparatus according to claim 8, further comprising a positioning pin, positioned on one of the matching element and the knob element, the positioning pin being moved in the slide groove of the supporting frame when the knob component is rotated, and the positioning pin being moved into the positioning hole when the knob component is rotated to the buckling position.

10. The supporting apparatus according to claim 8, wherein the propping part is positioned on the matching element.

11. The supporting apparatus according to claim 8, wherein the matching element and the knob component element are integrally formed.

12. The supporting apparatus according to claim 8, wherein the matching element is locked to the positioning part of the supporting frame through a screwing element.

13. The supporting apparatus according to claim 8, wherein the knob element is locking to the matching element through at least one screwing element.

14. The supporting apparatus according to claim 1, wherein when the knob component is rotated to the release position, the knob component is separated from the positioning part.
